(19) United States
(12) Patent Application Publication
(10) Pub. No.: US 2023/0233888 A1
(43) Pub. Date: Jul. 27, 2023

(54) RESPIRATOR MASK

(71) Applicant: Eurofilters Holding N.V., Overpelt (BE)

(72) Inventors: Ralf Sauer, Overpelt (BE); Jan Schultink, Overpelt (BE)

(73) Assignee: Eurofilters Holding N.V., Overpelt (BE)

(21) Appl. No.: 17/927,228

(22) PCT Filed: Apr. 13, 2021
(86) PCT No.: PCT/EP2021/059491

§ 371 Date: Nov. 22, 2022

(30) Foreign Application Priority Data
May 28, 2020 (EP) 20177101.1

(51) Int. Cl. A62B 23/02; A41D 13/11; B01D 39/16; B01D 39/18; D04H 1/4291; D04H 1/435; D04H 3/011; D04H 3/007; D04H 3/16; B32B 5/26; B32B 5/02; D04H 1/56; D04H 3/013; D04H 1/4258

(52) U.S. Cl. CPC A62B 23/025; A41D 13/11; B01D 39/1623; B01D 39/18; D04H 1/4291; D04H 1/435; D04H 3/011; D04H 3/007; D04H 3/16; B32B 5/269; B32B 5/022; D04H 1/56; D04H 3/013; D04H 1/4258; B01D 2239/0654; B01D 2239/0618; B01D 2239/0266; B01D 2239/0435; D10B 2509/00; D10B 2401/12; D10B 2321/022; B32B 2307/724; B32B 2571/00; B32B 2262/0253; B32B 2262/0284; B32B 2262/04; B32B 2250/20

(57) ABSTRACT

The invention relates to a respirator mask comprising a filter material piece made of an air-permeable material and at least one securing band, wherein the air-permeable material comprises at least one layer of a non-woven fabric and the at least one securing band is designed to secure the respirator mask to the head, wherein the air-permeable material and the at least one securing band are made of the same plastic material.

The invention relates to a respirator mask.

Respirator masks consistently cover the wearer's mouth and nose with a filter material and are used to protect them from airborne pollutants and to protect the environment from exhaled bacteria and viruses. In this regard, the term includes, among others, in particular a surgical mask, medical face masks and filtering half masks.

The filter material used nowadays generally consists of a non-woven fabric made of plastic material. Many respirator masks are intended for single use and are disposed of afterwards.

Given the ever-increasing demand for respirator masks, this results in a large amount of waste consisting of plastic material.

In view of this, the object underlying the invention is to provide an ecologically improved respirator mask with good filtering and protection properties.

This object is achieved by a respirator mask according to claim 1.

According to the invention, there is provided a respirator mask comprising a filter material piece made of an air-permeable material and at least one securing band, the air-permeable material comprising at least one layer of a non-woven fabric, the at least one securing band being designed to secure the respirator mask to the head, wherein the air-permeable material and the at least one securing band are made of the same plastic material.

The filter part of the respirator mask in the form of the filter material piece is accordingly made of an air-permeable material that may have a construction with one or more layers. At least one of these layers is a non-woven fabric. Since the plastic material of the air-permeable layer and thus of the filter part is the same as that of the securing band, the respirator mask according to the invention allows a simplified and thus ecologically advantageous recycling of the mask. Due to the homogenous plastic material used, there is no need for time-consuming separation into different components of different materials.

For the purposes of the present invention, a “non-woven fabric” means an entangled mesh which has undergone a bonding step (non-woven bonding step) so that it has sufficient strength to be wound into rolls or unwound from these, in particular by machine (i.e. on an industrial scale). The minimum web tension required for such a winding into rolls is 0.044 N/mm. The web tension should not be higher than 10% to 25% of the minimum maximum tensile force (according to DIN EN 29073-3:1992-08) of the material to be wound. This results in a minimum maximum tensile force for a material to be wound of 8.8 N per 5 cm strip width.

A “fibre web” (or just “web”) corresponds to an entangled mesh, which, however, has not undergone a bonding step, so that, in contrast to a non-woven fabric, such an entangled mesh does not have sufficient strength to be wound into rolls or unwound from these by machine, for example.

The term “non-woven fabric” is used in other words as defined in ISO standard ISO 9092:1988 or CEN standard EN 29092. Details on the use of the definitions and/or processes described therein may also be found in the textbook “Vliesstoffe”, H. Fuchs, W. Albrecht, WILEY-VCH, 2012.

“Fibres” refers to both fibres of finite length (e.g. staple fibres) and fibres of theoretically infinite length, i.e. continuous fibres or filaments.

The plastic material may be polypropylene, a polyester, in particular polyethylene terephthalate and/or a biodegradable plastic material.

Biodegradable plastic materials may be removed from the environment through biological degradation and returned to the mineral material cycle. In particular, “biodegradable plastic materials” refers to plastic materials that fulfil the criteria of the European standards EN 13432 and/or EN 14995.

The biodegradable plastic material may in particular comprise a polylactide (PLA), a polyhydroxyalkanoate (PHA), a polycaprolactone (PCL), a cellulose ester, in particular cellulose acetate, polybutylene adipate terephthalate (PBAT) or polybutylene succinate (PBS).

The non-woven fabric may be a dry-laid or wet-laid non-woven fabric or an extrusion nonwoven fabric, in particular a meltblown, spunbond or spun-blown non-woven fabric.

The at least one non-woven fabric may comprise staple fibres or continuous fibres. In terms of production engineering, several layers of staple fibres or continuous fibres may also be provided, which are bonded to form exactly one layer of non-woven fabric.

The air-permeable material may in particular comprise exactly one filtrating layer, wherein the exactly one filtrating layer corresponds to the at least one non-woven layer. A filtrating layer is defined here as a layer that is relevant for filtering the air flow to be filtered. The air-permeable material may further comprise a mesh. The mesh may be used for the aesthetic design, for example the colour design, of the respirator mask. The mesh may also be used to improve the stability of the filter material piece of the respirator mask. The mesh may be, for example, an extruded mesh or a woven mesh. The mesh may have a mesh size of at least 1 mm, in particular at least 3 mm. The mesh may be made of the same plastic material as the non-woven layer.

The air-permeable material may be single-layered or multi-layered, wherein at least one, more or all of the layers or are formed from a non-woven fabric.

The filter material piece or the air-permeable material may consist of a non-woven fabric layer. The filter material piece may be thus a single layer material, the single layer corresponding to the non-woven fabric layer. In this case, the non-woven layer may in particular be in the form of a meltblown layer or spun-blown layer. In particular, in this case, no support layer or reinforcing layer is provided for the non-woven layer. In other words, the non-woven fabric layer may be designed to withstand the usual stress of manufacture and use.

The at least one non-woven fabric may be a calendered non-woven fabric, in particular a non-woven fabric calendered thermally or by means of ultrasound. For thermal calendering, the initially unbonded non-woven may be passed between two rollers, at least one of which is heated to the melting temperature of the fibres forming the non-woven. At least one of the calendering rollers may have projections. As a result, fusion zone areas or spot welds may be formed.

Ultrasonic calendering or ultrasonic bonding is based on the conversion of electrical energy into mechanical vibration energy. In this process, bonding horns are caused to vibrate, whereby the fibres at their crossing points in the non-woven material are softened and welded together at the vibration points. This may lead to the formation of spot welds.

The air-permeable material may have a multi-layer structure, wherein at least one, more or all of the layers comprise or are formed from a non-woven fabric.

The air-permeable material may also comprise one or more additional layers which do not comprise a non-woven fabric, for example a mesh. In this case, the additional layers may also be made of the same plastic material as the non-woven fabric layer.

The at least one non-woven fabric layer may have a weight per unit area of 20 g/m² to 200 g/m², in particular 40 g/m² to 150 g/m², in particular 80 g/m².

The at least one non-woven fabric layer may have a maximum tensile force in the machine direction of more than 20 N, in particular more than 40 N, and/or in the transverse direction of more than 20 N, in particular more than 40 N.

The non-woven fabric layer may have an air permeability of 100 l/(m²s) to 1000 l/(m²s), in particular 300 l/(m²s) to 600 l/(m²s), in particular 400 l/(m²s) to 500 l/(m²s).

The air-permeable material may comprise at least one fine filter layer and/or at least one support layer, wherein at least one, more or all of the fine filter layers and/or at least one, more or all of the support layers are non-woven fabrics.

One or both carrier layers may be a non-woven fabric, in particular spunbonded or spun-blown. Alternatively, one or both carrier layers may be a mesh (netting). The mesh may have characteristics as described in EP 2 011 556 A1, which is hereby incorporated by reference.

A support layer (sometimes also called “carrier layer” or “reinforcing layer”) within the meaning of the present invention is a layer which provides the necessary mechanical strength to the multi-layer composite of the filter material piece. This refers to an open, porous non-woven fabric or a non-woven fabric with a light weight per unit area. One of the purposes of a support layer is to support other layers. The support layer, as well as any other layer of the filter material, may also be electrostatically charged, provided that the material has suitable dielectric properties.

A fine filter layer serves to increase the filtration performance of the multi-layer filter material piece by trapping particles that pass through the support layer, for example. To further increase the separation efficiency, the fine filter layer may preferably be electrostatically charged (e.g. by corona discharge or hydro charging).

Each support layer of the respirator masks may be a spunbonded or spun-blown non-woven, preferably with a grammage between 5 and 80 g/m², more preferably between 10 and 50 g/m², more preferably between 15 and 30 g/m² and/or preferably with a titre of the fibres forming the spunbonded non-woven in the range of 0.5 to 15 dtex.

The air-permeable material may preferably comprise one to three support layers.

When two support layers exist, the total grammage of the sum of all support layers is preferably 10 to 200 g/m², more preferably 15 to 150 g/m², more preferably 20 to 100 g/m², more preferably 30 to 90 g/m², in particular 40 to 70 g/m².

A support layer in the form of a spunbonded or a spun-blown non-woven may be made of PBAT (e.g. Ecoflex from BASF) or another biodegradable polyester such as Duvaltex.

According to a further embodiment, each fine filter layer is an extrusion non-woven fabric, in particular a meltblown non-woven fabric. The extruded non-woven fabric preferably has a grammage of 10 to 80 g/m², more preferably 15 to 50 g/m², in particular 20 to 40 g/m².

The air-permeable material may comprise 1 to 5 fine filter layers.

When at least two fine filter layers exist, the total grammage of the sum of all fine filter layers is preferably 10 to 80 g/m², more preferably 15 to 50 g/m², in particular 20 to 40 g/m².

One embodiment of the structure of the air-permeable material for the respirator mask according to the invention provides a multi-layer structure with a layer sequence described below:

a support layer, one or two fine filter layers and a further support layer.

In particular, if the support layer is constructed as a spunbonded non-woven fabric and the fine filter layer as a meltblown non-woven fabric, a SMS or SMMS structure is used. Instead of a spunbonded non-woven fabric layer, spun-blown non-woven fabric layers may also be used in this construction.

The at least one non-woven fabric layer may be electrostatically charged. In a multi-layer construction, one, several or all of the non-woven fabric layers may be electrostatically charged. In particular, a meltblown layer or a spun-blown layer may be electrostatically charged.

The fibres may be electrostatically charged before bonding and/or the non-woven fabric, i.e. after bonding. PP, PET or PLA in particular have proven to be advantageous for electrostatic charging.

The non-woven layer may be electrostatically charged by a corona process. Alternatively or additionally, the non-woven layer may be electrostatically charged by a process according to the teaching of U.S. Pat. No. 5,401,446. Another alternative consists in using additives and a water jet treatment (hydro charging) described for example in WO 97/07272.

In the respirator masks described, at least one, several or all of the non-woven fabric layers may be creped.

The creping of the non-woven fabric layer leads to an increase in the flow-through area and thus to a corresponding reduction in breathing resistance. For creping the non-woven layer, the Micrex/microcreper process may be used in particular. Merely by way of example, reference is made to WO 2007/079502.

The air-permeable material of the respirator mask may be creped. When the entire air-permeable material, i.e. all layers, are creped, an increased stretchability of the filter material piece is achieved, resulting in an improved fit of the respirator mask. Increasing the surface area through creping may further lead to a softer feel, improving skin-friendliness, and a better moisture absorption.

The crepe direction, i.e. the direction of the crepe folds, may be designed in such a way that the crepe folds run essentially horizontally or essentially vertically in the intended use of the respirator mask.

The respirator masks described may comprise a further filter material piece made of an airpermeable material, the further filter material piece comprising at least one layer of a non-woven fabric, which is made of the same plastic material than the non-woven fabric layer of the first filter material piece.

This allows in particular the manufacturing of a filtering half mask. The two filter material pieces, which form the filter part here, are disposed on top of each other.

The two filter material pieces of the respirator mask may have a polygonal shape, wherein the filter material pieces are not welded together along one edge. The shape of the filter material pieces may be rectangular or hexagonal in particular. Both filter material pieces may have the same shape and dimensions; in particular, they may fit exactly on top of each other.

The welding of the filter material pieces is an aspect independent of the welding of several layers of a filter material piece. Thus, along one edge of the two filter material pieces, these two may be welded together and each filter material piece may consist of several (previously) welded layers; however, the latter layer welding, which leads to a corresponding laminate, may lack or may also only be present at individual edges of the layers of a filter material piece.

Each filter material piece and/or the filter part of the (finished but unused) respirator mask may have (in plan view) a polygonal, in particular rectangular or hexagonal shape. In the hexagonal shape, two adjacent right angles may be provided.

The two filter material pieces may be welded together along all remaining edges. This leaves exactly one edge of the polygon unwelded. The unwelded edge creates the opening of the respirator mask for the face of the wearer/user. In the case of two filter material pieces or a filter part with a rectangular shape, the unwelded edge may in particular be an edge between two right angles.

These features allow the respirator mask to be manufactured very easily.

The features and properties of an air-permeable layer or filter material piece described above and below may be given and implemented in the same way for each of the filter material pieces or their air-permeable layer, in particular in the case of a respirator mask comprising two filter material pieces.

The filter part or each filter material piece may have a three-dimensional shape, for example caused by spatial reshaping. The latter in particular allows a more precise fit to the face shape, resulting in a lower leakage volume flow.

The at least one securing band may be constructed with one or more layers.

The at least one securing band may comprise or be formed from a thermoplastic polymer, in particular a biodegradable thermoplastic polymer. The thermoplastic polymer may in particular be a thermoplastic elastomer. It may be, for example, a thermoplastic polyurethane (TPU) or Vistamaxx. Thus a homogenous respirator mask is possible, as the air-permeable layer is also made of a polyester.

Alternatively, as already mentioned, PP or PLA in particular may be used for the single- or multi-layer securing band.

The at least one securing band may comprise or consist of a layer of a film and/or a layer of a non-woven fabric, for example a meltblown fabric. Alternatively or additionally, Vistamaxx (manufacturer: ExxonMobil Chemical) may be used as a material for the non-woven fabric.

At least one layer of the at least one securing band may be creped. The creped layer may be obtained, for example, by means of the Micrex micro-creping process. In the case of a multilayer securing band, the laminate of the multiple plies may be a creped material.

The creping of the creped layer of the at least one securing band may be stabilised by means of an adhesive applied, in particular an adhesive that is elastic in the cured state. A hot melt is particularly suitable as an adhesive. The adhesive may be applied to the creped layer in the form of one or more strips, in particular in the longitudinal direction of the securing band. This leads to an advantageous stabilisation or fixation of the crepe without affecting the overall elasticity of the securing band too much.

The securing band may be in the form of a laminate of a TPU film and a TPU meltblown, TPU spunbond or TPU spun-blown material. This construction results in good elasticity with a high stability of the securing band. Furthermore, such a securing band may be advantageously welded to the filter material piece.

In the case of a securing band in the form of a laminate comprising a film and a non-woven fabric, the film, in particular in the form of a cast film, may be laminated directly onto the non-woven fabric. Thus no additional adhesive is required.

The securing band may be configured as a torsade or twisted cord. This increases the wearing comfort. In this case, it is possible to prevent the twist from twisting back again by thermal fusing (e.g. ultrasonic welding).

The respirator masks described may comprise (exactly) two securing bands.

One or more securing bands may be designed to be guided around the back of the head of a wearer (user). Alternatively, one or more securing bands may be designed to be guided around a wearer's (user's) ear.

The at least one securing band may be designed as a closed strap. This means that the corresponding securing band has no loose or open end. This may be achieved, for example, by coupling both ends of a securing band to the filter part or the filter material piece. Alternatively, for example, the corresponding strap may be configured as a closed strap as such; it may therefore have a ring or loop shape.

According to an alternative, the respirator mask may have at least two, in particular four, securing bands with open or loose ends. This means that (only) one end of each securing band is attached to the filter part or a non-woven web. The open/loose ends of two securing bands each may be knotted.

The at least one securing band may extend over an entire length of the filter material piece or filter part. This allows that the at least one securing band runs with the air-permeable material during production and is cut together with the material (at the ends of the filter material piece).

In particular, two securing bands may be provided which extend over an entire length of the filter material piece or filter part. Preferably, these two securing bands are arranged on the same side of the air-permeable material or filter material piece and along two opposite edges of the filter material piece.

The at least one securing band may be coupled, in particular welded, to the air-permeable material at its two end regions.

The previously described respirator masks may include a bendable nosepiece. This allows to optimize the fit, in particular to enhance the sealing of the respirator mask in the eye and nose area, as well as to improve the retention.

In this case, the respirator mask may consist of the air-permeable material (or one or more filter material pieces), the at least one securing band and the nosepiece.

The nosepiece may be made of the same plastic material as the air-permeable material and the securing band. It may have one or more pre-breaks transverse to its longitudinal direction. These allow the nosepiece to be adapted advantageously to the shape of the face.

The nosepiece may be in a arrangement parallel to the non-welded edge. It may be placed on the outside of the respirator mask or embedded in one of the two non-woven webs.

The width of the nosepiece may be 1 to 10 mm. The length of the nosepiece may be 2 to 25 cm, in particular more than 4 cm and/or less than 10 cm. The nosepiece may also extend along the entire length of one edge of the filter material piece. This allows a simplified production, as the nosepiece may be cut together with the filter material piece during the production.

The nosepiece may be attached to the filter material piece in a destructively detachable or non-destructively detachable manner. The nosepiece may be glued or welded to the filter material piece. The fastening by means of adhesive may be done by a hot-melt adhesive. The nosepiece may be coupled to the filter material piece continuously along its entire length or only at individual discrete points.

The respirator masks described above may be configured as half masks. In use, they cover thus the wearer's nose, mouth and chin. The respirator masks described above may be configured as medical face masks according to DIN EN 14683:2019+AC:2019 or as filtering half masks according to DIN EN 149.

The invention further provides a system (kit of parts) comprising a respirator mask as previously described and a protective cover for the respirator, wherein the protective cover is made of the same plastic material as the air-permeable material and the securing band.

This enables an optimised recycling process for the respirator mask according to the invention, including its distribution and/or take-back. The protective cover may serve as a packaging during distribution (e.g. sale or dispatch) and/or during the take-back process (e.g. at appropriate collection points or a return shipment).

The protective cover may have a coding, for example a colour coding, to identify the plastic material used. A corresponding coding may also be provided on the respirator mask.

The present invention will be elucidated in more detail by means of the following exemplary embodiments with reference to the figures, without limiting the invention to the specific embodiments shown. In which:

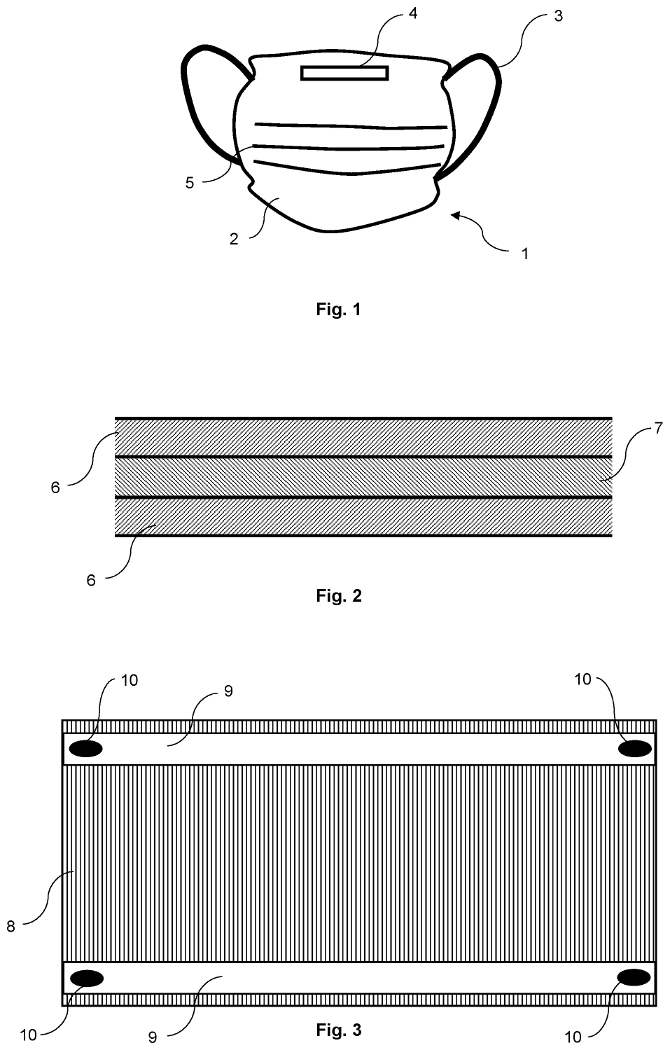

FIG. 1 schematically shows a respirator mask,

FIG. 2 shows a schematic cross-sectional view of the structure of a filter material piece of a respirator mask,

FIG. 3 shows a schematic top view of a respirator mask,

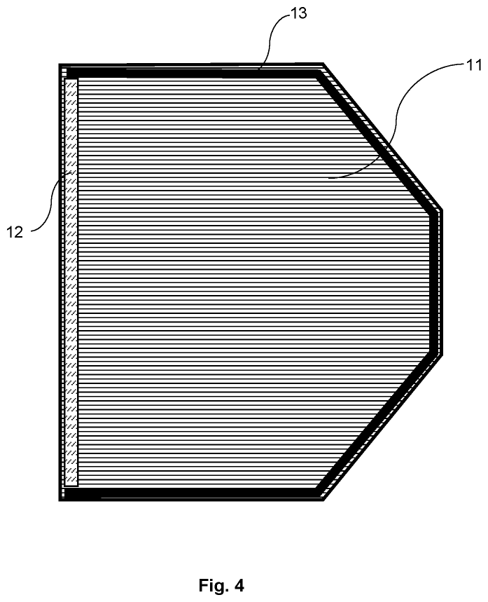

FIG. 4 shows a schematic side view of the filter part of a respirator mask.

FIG. 1 shows a schematic view of a respirator mask 1 in the form of a half mask. The description refers to an example of a medical face mask. The respirator mask 1 shown comprises exactly one filter material piece or filter part 2. The cutting shape of the filter material piece is basically rectangular, but may also take on other shapes, in particular polygonal shapes.

Two securing bands 3 are attached to the filter material piece 2 in the example shown. In the illustrated embodiment, the attachment straps are provided for attachment to the ears of the wearer.

For a better adaptation to the shape of the face, the respirator mask has a nosepiece 4 which is coupled to the filter material piece in a destructively or non-destructively detachable manner. This may in particular be a strip of plastic material provided with pre-breaks transverse to the longitudinal direction, similar to living hinges, to allow easy bending.

A destructive connection consists of welding, for example. The welding may either be disposed continuously along the entire length of the nosepiece or at individual discrete points. Alternatively, the nosepiece may be glued to the filter material piece. For example, a hot melt may be used for this purpose, which typically also results in a destructive connection.

Alternatively, the nosepiece is provided to the user as a separate element. In this case, the nosepiece has a self-adhesive surface that is initially covered with a protective film. After removing the protective film, the user sticks the nosepiece onto the non-woven fabric. Depending on the adhesive material used, such a nosepiece may also be reused for other respiratory protection filter parts.

In the exemplary embodiment, three folds 5 are disposed in the filter part or the air-permeable material 2.

The schematic cross-sectional view of FIG. 2 shows the structure of a filter material piece for a respirator mask. A fine filter layer 7 is arranged between two support layers 6. The three layers may in particular be welded together along the edges, i.e. the circumference, of the filter part 2, as illustrated in FIG. 1.

As an alternative to the structure shown in FIG. 2, the air-permeable material of the respirator mask may also comprise fewer or more layers. For example, only one fine filter layer or only one support layer with a fine filter layer may be provided.

The filter material piece 2, the securing bands 3 and the nosepiece 4 are all made of the same plastic material, so that a homogenous respirator mask is available. In particular, PP, PET or PLA may be used.

In one embodiment, the respirator masks have one or more layers made of PET, PP or PLA filaments or PET, PP or PLA staple fibres. Regarding the individual filter layers:

Spunbonded non-woven layers made with a weight per unit area of 5 to 50 g/m² and a titre of 1 to 15 dtex are particularly suitable as support layers 6.

One or more non-woven layers of meltblown or spun-blown material with a weight per unit area of 5 to 30 g/m² each are used as fine filter layers 7. At least this layer/these layers is/are electrostatically charged.

The filaments or staple fibres may also consist of bicomponent materials.

Specifically, the filter material piece may consist of a three-layer air-permeable material. A meltblown non-woven fabric layer with a grammage of 20 g/m² is arranged between two spunbonded non-woven fabric layers made of PP, PET or PLA with a grammage of 20 g/m². The SMS thus obtained may be ultrasonically welded by a weld seam running along the edges.

The meltblown or spun-blown non-woven fabric may be electrostatically charged by adding additives and a water jet treatment (hydro charging), as described for example in WO 97/07272.

Alternatively, the meltblown or spun-blown non-woven fabric may have a grammage of 25 g/m² and may have been electrostatically charged by means of a corona treatment.

The illustrated SMS was subjected to a Micrex micro-creping process. In other words, the entire laminate is creped. In an alternative embodiment, only individual layers may be creped. For example, the centrally located meltblown layer 7 may be creped, whereas the spunbonded support layers 6 are not creped. In this case, the support layers also serve to stabilise the creping of the meltblown, among other things. This is particularly advantageous if the material used for the meltblown layer per se does not readily hold the creping, as is the case for polypropylene, for example.

Purely by way of example, reference is made to WO 2007/079502 for creping. The resulting increase in surface area leads to a better fit of the respirator mask made from it to the shape of the wearer's head and face. It also results in a softer feel and improved moisture absorption.

FIG. 3 shows a schematic top view of an air-permeable material 8 corresponding to the filter part 2 of FIG. 1. However, in comparison with FIG. 1, FIG. 3 shows the rear of the filter part, i.e. the side facing a user.

In the example shown, a securing band 9 is arranged on opposite edges of the air-permeable material 8 and extends along the entire length of the edge. The securing bands may thus run with the air-permeable material during the production of the filter part and be cut together with the material. In the example shown, the securing band and the air-permeable material are joined by means of a welding point 10 at each of the opposite end regions of each securing band 9.

For the securing band, for example, a TPU laminate consisting of a TPU film with a thickness of 20 to 100 μm and a TPU meltblown non-woven (grammage: 20 to 80 g/m²) is used, which is welded to the filter material piece. For welding, the process disclosed in European patent applications EP 18213001.3 and EP 19180533.2 in another technical field may be used to achieve high strength.

The PP material produced according to the Vistamaxx process may have been produced by meltblown or foil casting or blown film processes and—as described for the TPU laminate—may have been laminated.

In the illustrated example according to FIG. 3, the air-permeable material is again creped as a whole. The crepe direction indicated by the hatching, i.e. the direction of the crepe folds, is vertical when the respirator mask is used as intended. In this example, the creping direction is transverse to the machine direction of the production machine, which runs from left to right in the drawing.

Preferably, the creping is done during production before the layers of the filter material piece are welded together. In this way, the creping is stabilised.

(Macroscopic) transverse folds—such as the folds 5 in FIG. 1—may be made in the filter material piece 8 parallel to the securing bands 9, transverse to the crepe folds. These folds are obtained by folding the air-permeable material so that areas of the air-permeable material lie on top of each other in the area of the folds or transverse folds in the finished, unused state of the filter material piece.

FIG. 4 shows a schematic side view of the filter part of a respirator mask. The filter section comprises two filter material pieces 11; only one of these is illustrated in FIG. 4.

Both filter material pieces have a hexagonal shape and fit exactly on top of each other. Thus, the filter part formed by the filter material pieces 11 welded together also has a hexagonal shape as such (in finished but unused state).

The edge on the left is disposed between two right angles, so it is bounded by two parallel edges that are perpendicular to the edge in between.

The air-permeable material of both filter material pieces is creped. The crepe direction is also indicated here by the hatching; the crepe folds run essentially horizontally, when the respirator mask made from the filter part is used as intended.

Each of the two filter material pieces 11 has a SMS structure, as explained, for example, in connection with FIG. 2. The three layers of a filter material piece have first been welded together along the edge between the two right angles, on the left side in the figure. The corresponding weld seam 12 of the filter material piece 11 shown runs parallel to the left edge.

The welding seam 13 along the remaining five edges is a welding of the two filter material pieces together. At these edges, there is no separate welding of the SMS layers of a filter material piece as such. On the side of the welding seam 12, however, the two filter material pieces are not welded together. This forms the open side of the respirator mask, which will face the wearer's face.

During manufacture thus, the three layers of SMS in the form of non-woven fabric webs are first laid loosely on top of each other and welded along one edge by means of the welding seam 12. The remaining five edges remain open, the layers therefore loose. The machine direction of the production machine is from top to bottom in the arrangement of FIG. 4, parallel to the welding seam 12. The SMS filter material web welded on one side only is then creped as a whole, wherein the creping direction, i.e. the direction of the creping folds, is transverse, i.e. essentially perpendicular to the machine direction or the welding seam 12.

Thereafter, two such creped SMS filter material webs are guided over each other in machine direction, i.e. in the direction of or parallel to the welding seam 12, so that they come to lie on top of each other. The two SMS filter material webs, i.e. the six layers of two SMS on the whole, are welded together along the welding seam 13, which forms five edges of the two filter material pieces lying on top of each other. The two filter material webs are punched along these edges, so that a filter part 11 is then obtained as shown in FIG. 4.

The resulting respirator mask is advantageously stretchable, in particular on its open side, i.e. in the area of the welding seam 12, which allows a good facial fit. In addition, due to the creping, the air permeability is high and the breathing resistance is low.

1. A respirator mask, comprising a filter material piece made of an air-permeable material and at least one securing band,
wherein the air-permeable material comprises at least one layer of a non-woven fabric,
wherein the at least one securing band is configured to secure the respirator mask to a user's head, and
wherein the air-permeable material and the at least one securing band are made of a same plastic material.

2. The respirator mask according to claim 1, wherein the plastic material is polypropylene, a polyester, or a biodegradable plastic material.

3. The respirator mask according to claim 2, wherein the biodegradable plastic material is a polylactide (PLA), a polyhydroxyalkanoate (PHA), a polycaprolactone (PCL), a cellulose ester, polybutylene adipate terephthalate (PBAT), or polybutylene succinate (PBS).

4. The respirator mask according to any of claim 2, wherein the biodegradable plastic material is a dry-laid or wet-laid non-woven fabric or an extrusion non-woven fabric.

5. The respirator mask according to claim 1, wherein the air-permeable material is single- or multi-layered, wherein at least one, more or all of the layers of the air-permeable material are made of a non-woven fabric.

6. The respirator mask according to claim 1, wherein the air-permeable material comprises at least one of fine filter layer or at least one support layer, and wherein at least one of the fine filter layers or at least one of the support layers is a non-woven fabric.

7. The respirator mask according to claim 1, wherein at least one of the non-woven fabric layers is electrostatically charged.

8. The respirator mask according to claim 1, wherein the air-permeable material is formed in multiple layers with a layer sequence comprising:
a support layer, one or two fine filter layers, and a further support layer, and wherein the support layer, the further support layer, or the one or two fine filter layers are each a non-woven fabric layer.

9. The respirator mask according to claim 1, wherein at least one of the non-woven fabric layers is creped.

10. The respirator mask according to claim 1, wherein the at least one securing band has a multi-layer construction, the securing band comprising a layer of a film and a layer of a non-woven fabric.

11. The respirator mask according to claim 1, wherein the securing band comprises or is formed from a thermoplastic polymer.

12. The respirator mask according to claim 10, wherein at least one layer of the securing band is creped.

13. The respirator mask according to claim 12, wherein the creping of the creped layer is stabilised by means of an adhesive applied.

14. The respirator mask according to claim 1, comprising a bendable nosepiece, made of a same plastic material as the air-permeable material and the securing band.

15. The respirator mask according to claim 1, wherein the respirator mask is configured as a medical face mask according to DIN EN 14683:2019+AC:2019 or as a filtering half mask according to DIN EN 149.

16. A system comprising a respirator mask according to claim 1 and a protective cover for the respirator mask, wherein the protective cover is made of a same plastic material as the air-permeable material and the securing band.

17. The respirator mask according to claim 2, wherein the polyester comprises polyethylene terephthalate.

18. The respirator mask according to claim 1, wherein the air-permeable material comprises at least one fine filter layer or at least one support layer.

19. The respirator mask according to claim 1, wherein the air-permeable material is formed in multiple layers with a layer sequence comprising: a support layer, one or two fine filter layers, and a further support layer.

20. The respirator mask according to claim 3, wherein the cellulose ester is cellulose acetate.
